(19) United States
(12) Patent Application Publication
(10) Pub. No.: US 2005/0253468 A1
(43) Pub. Date: Nov. 17, 2005

(54) Rim structure particularly for cycle wheel with variable magnetic field electric generator

(76) Inventor: Daniele Zampieri, Conselve (IT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/510,757

(22) PCT Filed: Apr. 9, 2003
(86) PCT No.: PCT/IB03/01292

§ 371 Date: May 27, 2005

(30) Foreign Application Priority Data
Apr. 9, 2002 (IT) PD2002U000029

(51) Int. Cl. H02K 21/12; H02K 15/14

(52) U.S. Cl. 310/75 C; 310/67 A; 29/596; 310/156.08

(57) ABSTRACT

A rim structure, in particular for bicycles equipped with a current generator of the variable magnetic field type, comprises a circumferentially extending tubular body (2) from which a pair of opposite flanges (3) defining a seat (4) for housing a tyre (P) extends outwards. According to the invention the tubular body (2) comprises at least one annular peripheral side pocket (5) able to house a plurality of permanent magnets (6) aligned along one circumference. Spacer means (7) are also envisaged, said means being inserted in the side pocket (5) in order to keep the permanent magnets (6) at predetermined distances from each other.

### TECHNICAL FIELD

The present invention is generally applicable in the field of wheeled vehicles and, in particular, relates to a rim structure, in particular for bicycles equipped with a current generator, as well as to a method and a machine for manufacturing this structure.

### BACKGROUND ART

As is known, in bicycles where an available supply of electricity is required in order to power applications such as the front light and rear light, generators—commonly referred to as “dynamos”—are used, said generators being essentially alternators which receive the driving movement from a knurled roller which is arranged so as make contact, via spring means, with one of the tyres of the bicycle.

In addition to the problems associated with deterioration of the moving parts which reduce the efficiency of the dynamo and cause a bothersome noise, the dynamo has the major disadvantage that the voltage which is generated is dependent upon the speed of movement of the bicycle.

In order to overcome the main problems associated with the dynamo, current generator devices which use variable magnetic fields have been developed.

These devices comprise a plurality of curved segments to be fixed to the spokes of the bicycle wheel, which support, in succession, a plurality of permanent magnets.

The fork of the bicycle has fixed thereto, on a corresponding support, a plurality of pole shoes with associated windings around which an induced current flows, said current being due to the passing movement of the magnets which, being spaced from each other, generate an alternating electrical field.

The pole shoes are then connected to electrical accumulators which allow energy to be supplied to the applications even when the bicycle is at a standstill.

This solution, however, also has problems associated in particular with the fact that there is a discontinuity in the succession of permanent magnets, since the curved segments are themselves arranged circumferentially spaced on the spokes.

The magnets are moreover not protected since they are arranged on curved segments which, being independent components on the outside of the bicycle wheel, may be moved, damaged and lost, being separated from the wheel itself.

WO00/59769 which is considered the nearest prior art to the invention, discloses a rim structure having all the features mentioned in the preamble of the appended claim 1, and having permanent magnets which are inserted in a side pocket of the rim of the bicycle wheel.

However, the insertion of the permanent magnets into said side pocket at regular distance with respect to each other is rather difficult and unreliable, and does not prevent undesirable movements or vibrations of the magnets.

WO02/00492 also discloses a rim structure equipped with a current generator of the variable magnetic field type. The current generator comprises plastic magnet holders with circular seats for housing a plurality of permanent magnets.

### DISCLOSURE OF THE INVENTION

A main object of the present invention is that of overcoming the abovementioned drawbacks by providing a rim structure which eliminates or substantially reduces the known problems associated with the supply of electricity to bicycles using current generators of the variable magnetic field type.

A particular object is that of providing a structure which, when combined with a suitable current generator, operates in a uniform and silent manner.

An additional object is that of providing a structure which allows a large number of permanent magnets to be used.

A further object of the invention is that of providing a structure which is able to protect the permanent magnets from dirt or accidental damage, preventing any dislodging or loss of efficiency of the said magnets during use.

Another particular object is that of providing a structure which is simple and economically advantageous in that it can be manufactured at a low cost using technology of the known type.

These objects, together with others which will appear more clearly below, are achieved by a rim structure in accordance with claim 1.

In a further aspect, the invention provides a method for manufacturing the above rim structure in accordance with claim 10.

Yet in a further aspects, the invention provides a machine for carrying out the above methond in accordance with claim 15.

Owing to this particular rim structure and manufacturing method it will be possible to use a large number of permanent magnets and to arrange them in a safe and reliable manner, avoiding undesirable movement or vibration thereof.

### BRIEF DESCRIPTION OF THE DRAWINGS

Further features and advantages of the invention will be more clearly understood in the light of the detailed description of some preferred, but not exclusive embodiments of a rim structure, a method for the manufacture thereof and a machine for implementing the method according to the invention, which are illustrated by way of a non-limiting example with the aid of the accompanying drawing sheets in which:

FIG. 1 shows a side view of a bicycle equipped with a rim having the structure according to the invention;

FIG. 2 shows a side view of a wheel portion comprising a rim with the structure according to the invention;

FIGS. 3 and 4 show two perspective views of respective enlarged details of a first example of embodiment of a structure according to the invention;

FIG. 5 and FIG. 6 show two perspective views of enlarged details of further examples of embodiment of a structure according to the invention;

FIG. 7 and FIG. 8 show two front views of a rim structure according to the invention, in two different configurations;

FIG. 9 shows a perspective view of a detail of the structures according to FIG. 5 and FIG. 6;

FIG. 10 shows a top plan view of a machine according to the invention;

FIG. 11 shows a side view of the machine according to FIG. 10;

FIG. 12 shows a block diagram of the manufacturing method according to the invention.

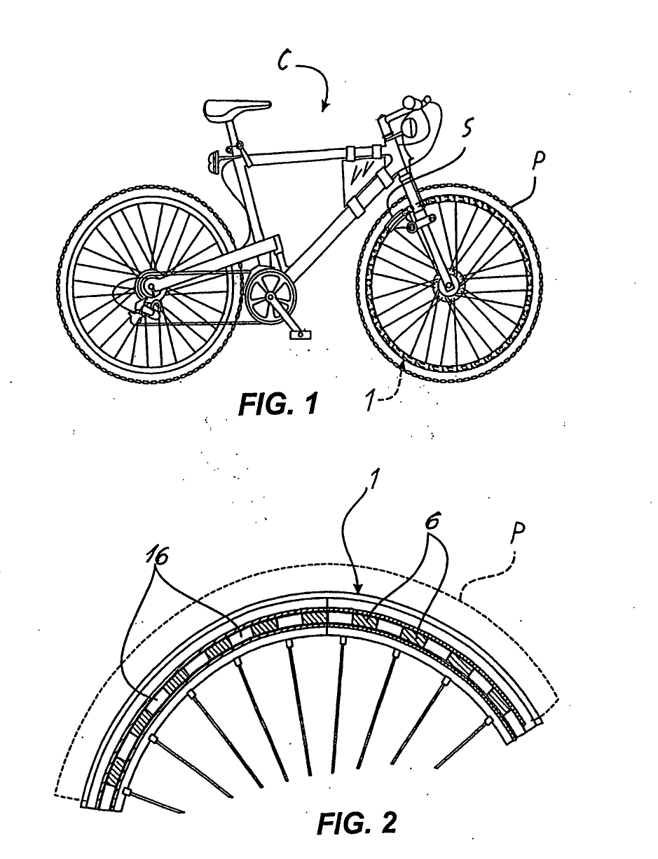

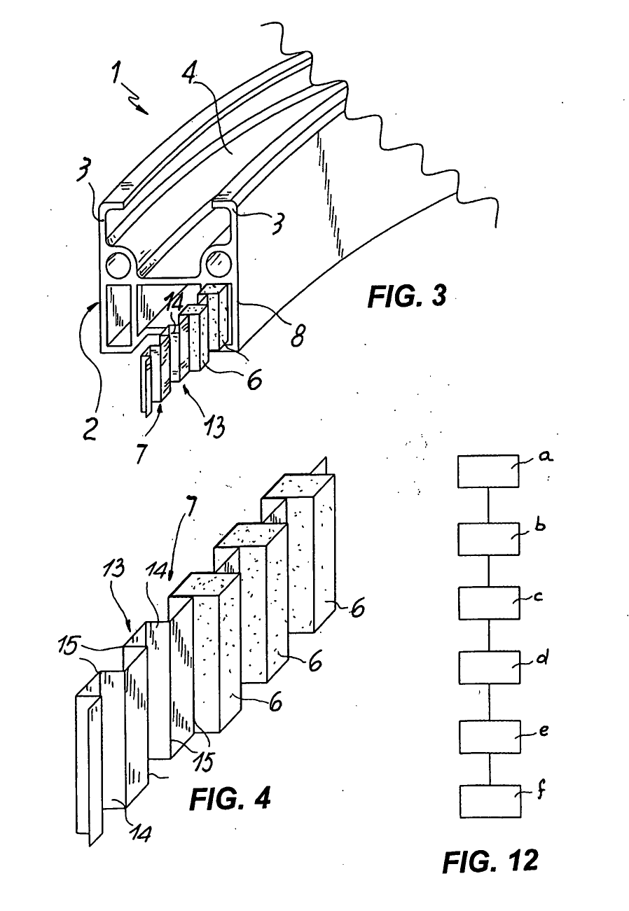

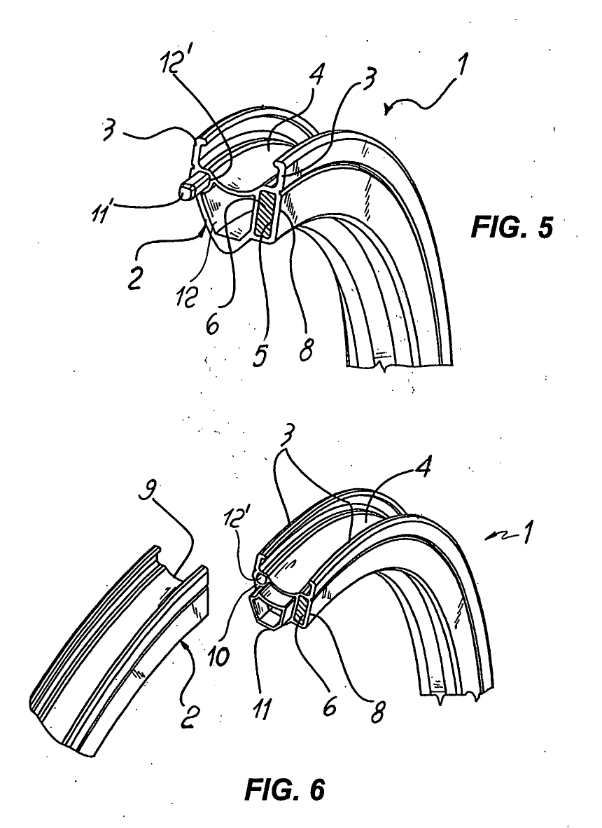

### DETAILED DESCRIPTION OF THE PREFERRED EMBODIMENT(S)

With particular reference to the above mentioned figures, a rim structure is shown according to the invention, denoted in its entirety by the reference number 1.

The rim structure 1 is mounted on a bicycle C equipped with a current generator of the variable magnetic field type, known per se.

The rim 1 comprises a peripherally or circumferentially extending tubular body—denoted in its entirety by the reference number 2—from which a pair of opposite flanges 3 defining a seat 4 for housing a tyre P extends outwards.

According to the invention, the tubular body 2 comprises at least one annular peripheral side pocket 5 which is able to house a plurality of permanent magnets 6 aligned along a circumference. Moreover, spacer means, denoted overall by the reference number 7, are envisaged, said spacer means being inserted inside the side pocket 5 so as to keep the permanent magnets 6 suitably directed and situated at predetermined distances from each other.

When the rim 1 is rotated, the permanent magnets 6 generate a variable electric field on the windings of corresponding pole shoes—not shown in the drawings and of a type known per se—facing the permanent magnets 6 and arranged on a corresponding support S fixed to the frame of the bicycle C so as to follow the curved profile of the side pocket 5.

The windings of the pole shoes, although not shown in the drawings, are connected to a voltage rectifier and stabilizer unit which is in turn connected to an electric energy accumulator, which are both of a type known per se.

Preferably the distances between the permanent magnets 6 are substantially the same along the entire extension of the tubular body 2. Moreover, the side pocket 5 may have a quadrilateral, for example approximately trapezoidal, cross-section, with an external annular wall 8 which is substantially flat and perpendicular to the axis of rotation of the rim 1.

The tubular body 2 may have a pair of longitudinal ends 9, 10 facing each other and connected by means of a pin 11. The tubular body 2 may comprise a main cavity 12 which extends circumferentially and inside which the pin 11 may be inserted at the facing ends 9, 10. As an alternative or in addition to the main cavity 12, the tubular body 2 may comprise a secondary cavity 12′ inside which it is possible to insert a second suitably shaped pin 11′. The secondary cavity 12′ may be positioned opposite the side pocket 5. The pin 11 inserted into the main cavity 12 and the pin 11′ inserted into the secondary cavity 12′ have an external surface with a shape matching the internal surface of the corresponding main cavity 12 and secondary cavity 12′ and have dimensions such that they may be inserted inside the latter by means of interference.

The tubular body 2 may be made of metallic material, such as for example aluminium alloy, or synthetic material, such as for example PVC or another polymer, or also a composite material, such as a reinforced polymer or carbon fibres.

The permanent magnets 6 may be preferably made of an alloy composed of neodymium-iron-chromium in different percentages depending on the desired electrical power. The permanent magnets 6 may also be treated with zinc or nickel.

In a first preferred example of embodiment, the spacer means 7 may comprise an annular strip 13 of deformable laminar material inserted inside the side pocket 5. The permanent magnets 6 may be fixed to the strip 13 inside suitable shaped seats 14 able to receive them.

Suitably the shaped seats 14 may be formed by transverse folds 15 able to provide an undulating profile.

In greater detail, the base material of the strip 13 may be chosen from among non-magnetic or ferromagnetic materials. Yet, the base material may be chosen from among synthetic or composite materials which are suitably reinforced.

In a further preferred example of embodiment, the spacer means 7 may consist of a plurality of non-magnetic inserts 16 which are for example made of synthetic material and arranged inside the side pocket 5 alternating with the permanent magnets 6.

The rim structure 1 described above may be advantageously manufactured by means of a method comprising the following steps.

During a first step a), a linear tubular body 2 having a length substantially equal to the circumferential extension of the rim structure is prepared.

During the following steps b) and c), a plurality of permanent magnets 6 as well as suitable means 7 for spacing said magnets are prepared.

During a fourth step d) the plurality of permanent magnets 6 and the spacer means 7 are inserted inside the side pocket 5 of the tubular body 2 so as to keep the permanent magnets 6 at predetermined distances from each other.

During a fifth step e) the tubular body 2 is bent so as to provide the latter with a circular shape with the longitudinal ends 9, 10 substantially aligned.

During a final step f) the longitudinal ends 9, 10 are joined together so as to provide a continuous rim structure 1.

The step e) may be performed before or after the step d) for insertion of the permanent magnets 6 and the spacer means 7.

In a first example of embodiment the spacer means 7 may consist of a strip 13 of laminar material. The latter may be made by means of plastic deformation, for example by means of moulding, so as to provide a plurality of shaped seats 14 with folded edges 15 at predetermined distances from each other for receiving the permanent magnets 6.

Once the shaped seats 14 have been formed, the permanent magnets 6 may be fixed there by means of an interference fit. Then the strip 13, together with the permanent magnets 6, may be inserted inside the side pocket 5 substantially along the entire longitudinal extension of the tubular body 2 and may be cut at the longitudinal ends 9, 10 of the latter.

In a second example of embodiment, the spacer means 7 may consist of non-magnetic inserts 16. In this case, the permanent magnets 6 may be inserted inside the side pocket 5 alternating with the non-magnetic inserts 16.

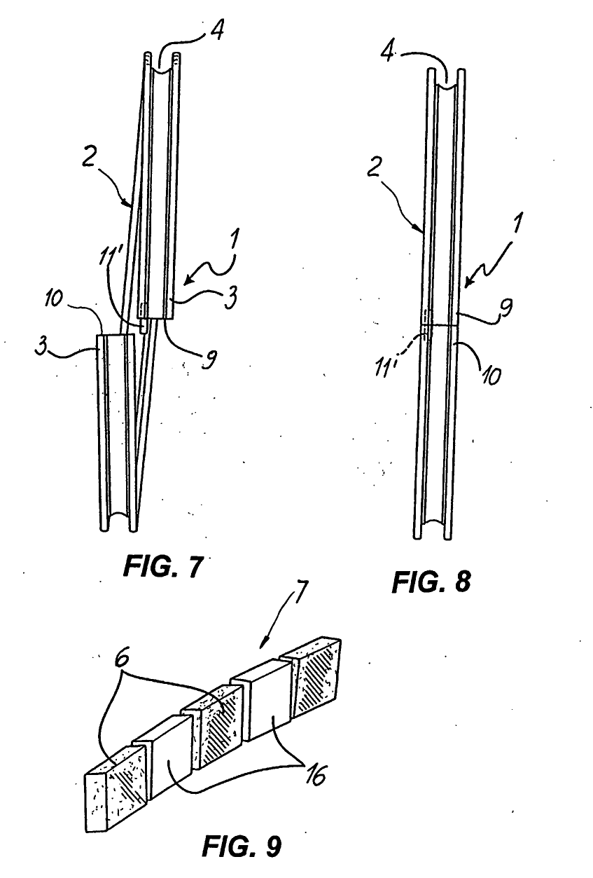

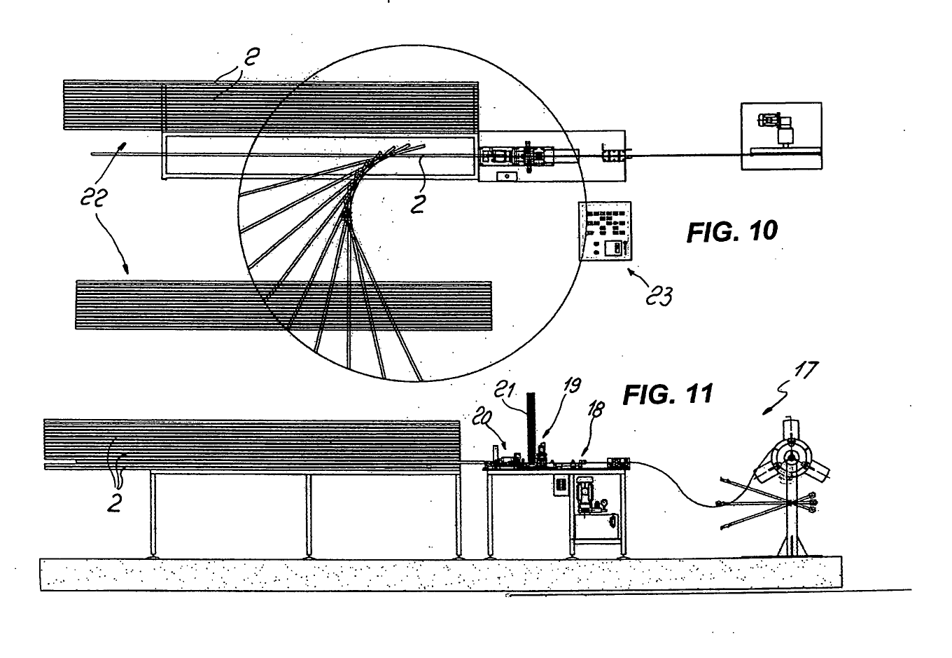

Advantageously, the insertion step d) may be performed after the step e) for bending the tubular body 2. In particular the longitudinal ends 9, 10 may be moved away from each other transversely, by elastically deforming the tubular body 2 as shown in FIG. 7, so as to allow access to the side pocket 5 and the alternating insertion of the permanent magnets 6 and the non-magnetic inserts 16 until the said pocket is completely filled.

The method described, with respect to solely the first example of embodiment of the rim structure 1, is implemented by means of a machine which is denoted overall by 17.

The machine 17 may comprise means 18 for continuous feeding a strip 13 of laminar material, means 19 for fixing a plurality of permanent magnets 6 onto the strip 13, and means 20 for inserting the strip 13, together with the permanent magnets 6, inside the linear tubular body 2 of predetermined length.

The machine 17 may also comprise, even though not shown in the drawings, means for cutting the strip 13 at the longitudinal ends 9, 10 of the tubular body 2, means for bending the tubular body 2, and means for joining together the longitudinal ends 9 of the tubular body so as to provide a unitary rim structure 1.

In particular, the fixing means 19 may comprise means for deforming the strip 13, so as to provide a plurality of shaped seats 14 at predetermined distances from each other, and a dispenser 21 for loading permanent magnets 6 into each shaped seat 14.

Suitably, the machine 17 may comprise a pair of racks 22 for collecting the tubular bodies 2, before the latter are bent, and a control console 23 for an operator.

From that described above, it is obvious that the rim structure according to the invention achieves the predefined objects and in particular allows the provision of a large number of permanent magnets and a drastic reduction in the risk of damage to or deterioration in the properties of the said magnets.

The rim structure, the manufacturing method and the machine according to the invention as defined in the accompanying claims may be subject to numerous modifications and variations all falling within the inventive idea expressed in the accompanying claims. All the details may be replaced by other technically equivalent elements and the materials may differ according to the requirements, without departing from the scope of the invention.

Although the rim structure, the manufacturing method and the machine have been described with particular reference to the accompanying figures, the reference numbers used in the description and the claims are used in order to facilitate understanding of the invention and do not limit in any way the scope of protection claimed.

1. A rim structure for bicycles equipped with a current generator of the variable magnetic field type, comprising: a circumferentially extending tubular body from which a pair of opposite flanges extends outwardly to define a seat for housing a tire, said tubular body including at least one annular peripheral side pocket for housing a plurality of circumferentally alligned permanent magnets, spacer means being inserted in said annular side pocket in order to keep said permanent magnets at predetermined distances from each other, said spacer means including an annular strip which is inserted inside said side pocket and to which said permanent magnets are fixed, characterised in wherein said strip has a plurality of shaped seats able to receive corresponding permanent magnets said shaped seats formed of transverse alternating folds providing an undulated profile.

2. The rim structure according to claim 1, wherein said predetermined relative distances are substantially the same along the entire extension of said tubular body.

3. The rim structure according to claim 1, wherein said side pocket has a quadrilateral cross-section, with an external side wall arranged in a plane substantially perpendicular to the axis of rotation of the rim.

4. The rim structure according to claim 1, wherein said tubular body has longitudinal ends facing each other and connected by means of a pin.

5. The rim structure according to claim 4, wherein said tubular body comprises an annularly extending main cavity inside which said pin is inserted with interference at said facing ends.

6. The rim structure according to claim 4, wherein said tubular body comprises a secondary cavity inside which a corresponding pin is inserted with interference at said longitudinal facing ends.

7. The rim structure according to claim 1, wherein the base material of said strip is chosen from among ferromagnetic or non-magnetic metallic materials.

8. The rim structure according to claim 1, wherein the base material of said strip is chosen from among synthetic materials or composite materials which are suitably reinforced.

9. The rim structure according to claim 1, wherein said spacer means comprises a plurality of non-magnetic inserts which are arranged inside said side pocket, alternating with said permanent magnets.

10. A method for manufacturing a rim structure, comprising the steps of
a) preparing a substantially straight tubular body having a length substantially equal to the circumferential extension of the rim structure;
b) preparing a plurality of permanent magnets;
c) preparing means for spacing said permanent magnets;
d) inserting said plurality of permanent magnets and said spacers inside a side pocket of said tubular body so as to keep said permanent magnets at predetermined distances from each other;
e) bending said substantially straight tubular body so as to provide it with a circular form having substantially aligned longitudinal ends;
f) joining together said longitudinal ends so as to provide a continuous rim structure,
wherein said step of preparation of said means for spacing said permanent magnets comprises preparing a strip of laminar material and subjecting said strip to plastic deformation to provide a plurality of seats at predetermined distances from each other and being shaped to receive said permanent magnets.

11. The method according to claim 10, wherein said bending step e) is performed after said step d) for inserting said permanent magnets and said spacer means.

12. The method according to claim 10, wherein said bending step e) is performed before said step d) for inserting said permanent magnets and said spacer means.

13. The method according to claim 10, wherein said permanent magnets are fixed inside said corresponding shaped seats by means of an interference fit.

14. The method according to claim 13, wherein said strip with said permanent magnets is inserted inside said side pocket substantially along the entire longitudinal extension of said tubular body and is cut at the longitudinal ends of the latter.

15. A machine making a rim comprising: means for continuously feeding a strip of laminar material, means for fixing a plurality of permanent magnets onto said strip, means for inserting said strip together with said permanent magnets inside a linear tubular body of predetermined length, means for cutting said strip at a longitudinal end of said tubular body, means for bending said tubular body, and means for joining together the longitudinal ends of said tubular body so as to provide a unitary rim structure, wherein said fixing means comprise means for deforming said strip so as to provide a plurality of shaped seats at predetermined distances from each other.

16. The machine according to claim 16, wherein said fixing means further comprises a dispenser for loading one permanent magnet inside each of said shaped seats.
